(19) United States
(12) Patent Application Publication
(10) Pub. No.: US 2009/0231880 A1
(43) Pub. Date: Sep. 17, 2009

(54) BACKLIGHT UNIT WITH HEALTH-CARE FUNCTION

(75) Inventors: Tae-young KWON, Seoul (KR); Jeong-hoon LIM, Seoul (KR)

Correspondence Address: CANTOR COLBURN, LLP, 20 Church Street, 22nd Floor, Hartford, CT, 06103, US

(73) Assignee: QRAY INC., Seongnam-si (KR)

(21) Appl. No.: 12/257,844

(22) Filed: Oct. 24, 2008

(30) Foreign Application Priority Data
Mar. 17, 2008 (KR) 10-2008-0024347
Oct. 2, 2008 (KR) 10-2008-0096877

(51) Int. Cl. F21V 7/04

(52) U.S. Cl. 362/612

(57) ABSTRACT

A backlight unit with a health-care function is disclosed. The backlight unit includes: a light source including a plurality of light-emitting diodes (LEDs), at least some of the plurality of LEDs radiating light having a wavelength beneficial to the human body; and an optical output unit outputting the light radiated from the light source to a liquid crystal panel. By using a monitor or mobile phone adopting the backlight unit, immunity is improved.

CROSS-REFERENCE TO RELATED APPLICATIONS

This application claims priority from Korean Patent Application No. 10-2008-0024347, filed on Mar. 17, 2008, and Korean Patent Application No. 10-2008-0096877, filed on Oct. 2, 2008, the disclosures of which are incorporated herein in their entireties by reference.

### BACKGROUND

1. Field

The following description relates to a backlight unit, and more particularly, to a light source of a backlight unit.

2. Description of the Related Art

Displays for digital and media equipment come in various types such as CRTs, PDPs, LCDs, and organic ELs. Among the various types of displays, TFT-LCDs have lately been attracting attention. A TFT-LCD can include three units: a panel in which liquid crystal is injected between two substrates; a printed circuit board (PCB) on which a driver LSI (large-scale integration) for driving the panel and various circuit devices are mounted; and a chassis structure including a backlight for providing a light source. The backlight is essential because the TFT-LCD itself cannot radiate light.

The light source used in the backlight may be a fluorescent lamp, LED lamp, etc. A Cold Cathode Fluorescent Lamp (CCFL) has commonly been used as a light source for a backlight, but the introduction of LCDs onto the market is revealing many problems in price competitiveness, process improvement, etc. Accordingly, LEDs, which have advantages of good color reproduction, high luminous efficiency, low power consumption, light weight, thinness, etc., are being adopted as a light source for a backlight.

Meanwhile, a variety research has been conducted into the effects of visible light on localized parts as well as the whole of the human body. In particular, many findings linking visible light to the improvement of fine blood circulation, acceleration of wound healing, abatement of pain, adjustment of circadian rhythm, etc. have been reported. Following this trend, therapeutic systems using visible light are becoming a new natural alternative in medicine. Since the possibility of alternative medical treatment with therapeutic systems using visible light was first widely recognized in the late 1980s, remarkable technological progress has been made. Particularly, it is a well-known fact that light has a significant influence on mood as well as physical and mental health. For example, it has been widely proven that Low Level Light Therapy (LLLT) using light having a short-wavelength narrowband is effective in abating pain and healing wounds.

Research into a correlation between visible light and immune function can be summarized as follows.

Immune function can be classified into two types: one is humoral immunity which antibodies such as immunoglobulin mediate, and the other is cell-mediated immunity managed by T lymphocytes. Visible light can influence both types of immunity. Irradiation by ultraviolet light usually only effects the skin, because short-wavelength ultraviolet light cannot pass through the dermis. Thus, it mainly acts to control cell-mediated immunity in the skin. Since visible light having the wavelength range of 380-780 nm penetrates the outer and inner layers of the skin and reaches superficial blood vessels, visible light can influence the blood as well as the skin.

According to research by Samoilova, et al. (2004), in irradiation by visible light, unlike irradiation by ultraviolet light, a structural or functional change of even a small amount of blood cells is transferred directly through blood vessels to the entire circulatory system.

Zhevago, et al. (2004) reported that irradiation by visible light causes the density of serum immunoglobulin to change and the levels of immunoglobulin M and immunoglobulin A to sharply increase.

Also, Kubasova, et al. (1995) found that when cells cultured in a test tube are irradiated with a combination of low-intensity visible light and infrared light, the formation of lymphocyte subsets is enhanced.

Mach, et al. (1999) reported that T lymphocytes, which manage a central function of cell-mediated immunity, play a central role in acceleration of wound healing using visible light.

Takezaki, et al. (2006) reported that when a biopsy was performed on skin irradiated by 630 nm visible light for 8 weeks, T lymphocytes gathered in the irradiated area of skin.

However, the conventional research is limited to treatment of skin diseases or healing of localized wounds. Also, there has been no discussion of whether irradiation by visible light under some conditions can improve human body cell-mediated immunity managed by T lymphocytes.

### SUMMARY

The following description relates to a backlight unit for improving the immunity of the human body.

According to an aspect, there is provided a backlight unit with a health-care function, including: a light source including a plurality of light-emitting diodes (LEDs), at least some of the plurality of LEDs radiating light having a wavelength beneficial to the human body; and an optical output unit outputting the light radiated from the light source to a liquid crystal panel.

It is preferable that the at least some of the LEDs radiates light having an incoherent wavelength of 610±20 nm or 710±30 nm.

By installing LEDs emitting 610 nm or 710 nm wavelength light in a backlight unit, a display, such as a monitor or an LCD for a cellular phone, in which the backlight unit is adopted can improve the immunity of the human body. Particularly, when a user who has to work on a computer for many hours uses a monitor with the backlight unit, he or she may gain the benefit of naturally improved immunity only by spending time in front of the monitor.

Additional aspects of the invention will be set forth in the description which follows, and in part will be apparent from the description, or may be learned by practice of the invention.

It is to be understood that both the foregoing general description and the following detailed description are intended to enable those of ordinary skill in the art to embody and practice the claimed invention, but not to limit the scope of the invention in any way.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain aspects of the invention.

FIG. 1 is a block diagram of a backlight unit according to an embodiment of the present invention;

FIG. 2 shows an example of a plurality of light sources having the structure shown in FIG. 1 arranged on a substrate;

FIG. 3 shows an example of two light-emitting diodes (LEDs) connected in parallel;

FIG. 4 shows an example of a lighting package;

FIG. 5 is a cross-sectional view showing a light guide panel and a lighting package that is to be inserted into the light guide panel;

FIG. 6 is a cross-sectional view showing a light guide panel and a lighting package inserted into the light guide panel;

FIG. 7 is a diagram showing results obtained by measuring CD4+ and CD8+ T-cell population of experimental groups using a flow cytometer before the experimental groups are irradiated by LED light;

FIG. 8 is a diagram showing results obtained by measuring CD4+ and CD8+ T-cell population of experimental groups using a flow cytometer after the experimental groups are irradiated by LED light for 28 days;

FIG. 9 is a flow cytometry data diagram showing the distributions of CD4+ and CD8+ T-cell population of experimental groups after the experimental groups are irradiated by 610 nm and 710 nm LED light for 4 weeks;

FIG. 10 is a diagram showing results obtained by measuring CD4+ and CD8+ T-cell population of experimental groups using a flow cytometer after irradiation of the experimental groups by LED light is stopped for 5 weeks;

FIG. 11 is a photograph of Interleukin 1β (IL-1β) Polymerase Chain Reaction (PCR) products;

FIG. 12 is a photograph of IL-4 PCR products;

FIG. 13 is a photograph of IL-6 PCR products; and

FIG. 14 is a photograph of IFN [symbol] PCR products.

### DETAILED DESCRIPTION OF EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

When a human body is irradiated by visible light in a specific wavelength band, photons transfer energy to a photoreceptor material, which generates a series of photochemical reactions. This means that photoreceptors are electronically excited by absorbing light, and transfer and amplify signals through a secondary biochemical reaction. Also, since light energy breaks the chemical bonds of transcription protein in cell membranes and accelerates the introduction of ions (for example, calcium ions) participating in signal transmission into cells so that signal molecules (for example, cAMP) are activated and induce the synthesis of nucleic acids and protein, cell division and proliferation are accelerated.

In the course of research into phototherapy using visible light, the applicant found that visible light of a specific wavelength band activates a protein structure for transcribing information and affects cell-mediated immunity managed by T lymphocytes, thereby improving immunity more effectively than conventional visible light therapy. The applicant completed the present invention by applying this finding to a backlight unit.

The present invention is different from other conventional techniques in terms of wavelength band and optical interference. Particularly, while conventional low-density phototherapy using short-wavelength narrowband light affects localized parts of a human body, the present invention uses visible light of a specific wavelength band capable of improving cell-mediated immunity of the entire human body.

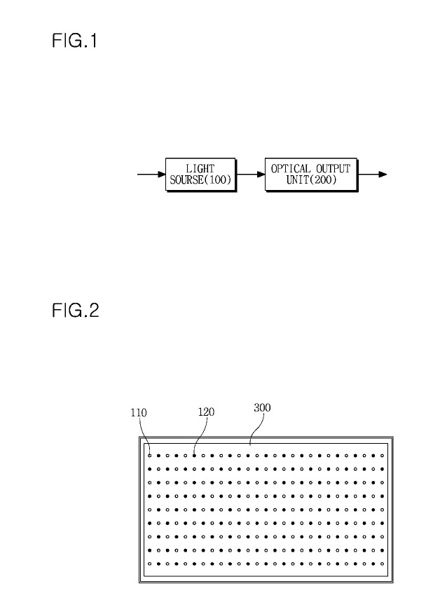

FIG. 1 is a block diagram of a backlight unit according to an embodiment of the present invention. The backlight unit includes a light source 100 and an optical output unit 200. The light source 100 includes a plurality of light-emitting diodes (LEDs). At least some of the LEDs have a specific visible light wavelength which is beneficial to the human body. According to an aspect of the present invention, some of the LEDs radiate light of a specific incoherent wavelength in the range of 610±20 nm or 710±30 nm, or more restrictively, 610±5 nm or 710±5 nm.

The optical output unit 200 is used to output light radiated from the light source 100 to a display panel which cannot emit light by itself. The optical output unit 200 includes a light guide panel, a diffusion sheet, a prism sheet, etc. Here, the light guide panel may or may not be included in the backlight unit depending on the type of the backlight unit. The backlight unit can be classified as a light guide panel type or a direct type according to the position of a light source. In the light guide panel type, a light source is disposed at a side of a light guide panel (LGP), a light beam from the light source is converted into a surface light source when passing through the light guide panel, and the surface light source illuminates a display panel. In the direct type, a light source radiates light from the rear side of a display panel toward the front side.

The direct type backlight requires no light guide panel since it radiates light from the rear side of a display panel toward the front side. Such a light guide type backlight can be classified as a wedge type LGP in which a light source is disposed at a side of a slanting light guide panel, or a flat type LGP in which light sources are disposed at both sides of a light guide panel. Since the wedge type LGP uses a linear light source in which LEDs are connected in a line and accordingly a small number of LEDs is used, the wedge type LGP is mainly used in an LCD for a notebook computer requiring low power consumption. In the flat type LGP, which is aimed at high brightness, since light sources are disposed at both sides of a light guide panel and accordingly the flat type LGP is thick, the flat type LGP is mainly used in a monitor. Also, the direct type is mainly used in applications such as LCD TVs requiring a large size and high brightness.

Meanwhile, the backlight unit can further include a filter, which is not shown in the drawings. The filter is used to sharply limit the wavelength band characteristics of visible light radiated from LEDs. By sharply limiting the wavelength band of light emitted from LEDs using the filter, the effects of 610 or 710 nm light on immunity can be maximized.

Hereinafter, the backlight unit according to the present invention will be described in detail.

According to an embodiment, a plurality of LEDs are constructed as a plurality of lighting packages which appear like a single lighting. According to an embodiment, the lighting packages may be general lighting packages functioning as backlights in the backlight unit, or health-care lighting packages. Here, LEDs included in the health-care lighting packages radiate visible light of a specific incoherent wavelength in the wavelength range of 610±20 nm (610±5 nm) or 710±30 nm (710±5 nm). As is well known to those skilled in the art, the general lighting packages are RGB LEDs radiating light with red (R), green (G) and blue (B) colors.

FIG. 2 shows an example of the lighting packages of the backlight unit arranged on a substrate 300.

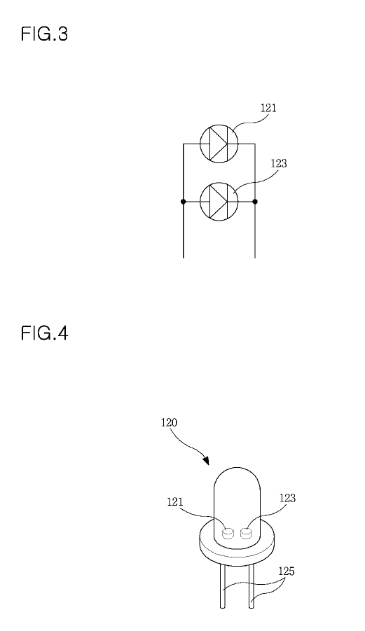

Referring to FIG. 2, general lighting packages 110 functioning as backlights are represented by white and health-care lighting packages 120 are represented by black. As illustrated in FIG. 2, according to an embodiment, the general lighting packages 110 and the health-care lighting packages 120 are arranged in alternating fashion. This arrangement is aimed to uniformly radiate light having a wavelength beneficial to the human body throughout the entire display panel. Also, LEDs 121 and 123 constructing each health-care lighting package 120 are connected to each other in parallel, as illustrated in FIG. 3. Accordingly, only two electrodes 125 (see FIG. 4) of each health-care lighting package 120 are exposed to the outside. By electrically connecting only two electrodes of each lighting package 120 to neighboring LEDs, a process of configuring electrodes can be simplified compared to a serial connection method.

In addition to the RGB LEDs, the general lighting packages can further include one or more LEDs for radiating visible light of a specific incoherent wavelength in the wavelength range of 610±20 nm (610±5 nm) or 710±30 nm (710±5 nm).

According to another embodiment, the backlight unit according to the present invention can be implemented by installing one or more LEDs for radiating visible light of a specific incoherent wavelength in the wavelength range of 610±20 nm (610±5 nm) or 710±30 nm (710±5 nm) in general lighting packages which are RGB LEDs, without installing separate health-care lighting packages. That is, it is possible to install one or more LEDs for radiating light having a wavelength which is beneficial to the human body in general lighting packages which have been conventionally used in a backlight, without having to install separate health-care lighting packages.

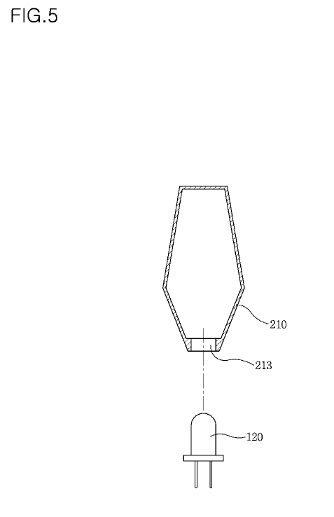

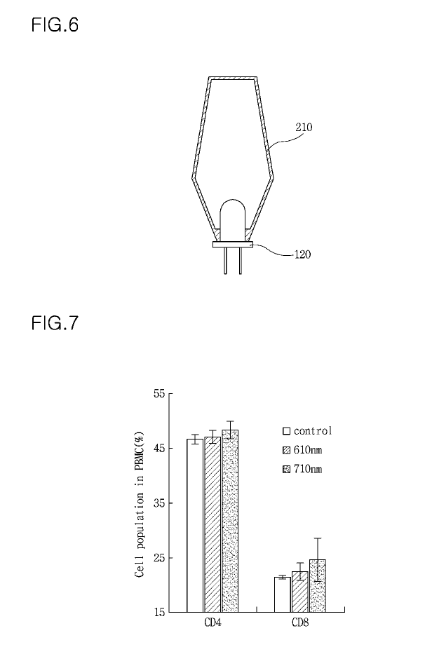

According to another embodiment, in the above-mentioned LGP types, the lighting packages are inserted respectively into holes formed in a light guide panel. As illustrated in FIGS. 4 and 5, a health-care lighting package 120 (or a general lighting package) is inserted into a hole 213 formed in a light guide panel 210. This structure is suitable for a mobile communication terminal such as a mobile phone requiring a small size.

As described above, the present applicant adopted, as a light source for a backlight unit, LEDs for radiating light in wavelength bands centered on 610 nm and 710 nm in the visible light region to effectively interact with T lymphocytes. Then, the present applicant performed a test of applying LED light to the in vivo rat model. The aim of the test was to investigate the effects of LED irradiation at 610 nm and 710 nm on T lymphocyte subset population using Flow cytometric assay and reverse transcriptase-polymerase chain reaction (RT-PCR) when the LED light is applied to the in vivo rat model. The test was performed as follows.

### Animals and Animal Care

Thirty 8 week-old, pathogen-free, male Sprague-Dawley rats were used in this study and maintained in a room at 22° C. under a 12 hour light/dark cycle; food and water were provided ad libitum. The room was illuminated by incandescent lamps (luminous flux; 11.77 lm). The breeding colonies were located at the Institute of Biomedical Science and Technology in Konkuk University and all animal protocols were approved by the Institutional Animal Care and Use Committee (IACUC) of Konkuk University.

### Irradiation Procedure

Two types of LED light sources were used with the following technical characteristics:
\textcircled{1} peak wave length: 610(±20) nm or 710(±30) nm
\textcircled{2} radiant power: 0.047 mW
\textcircled{3} irradiation area: 1.13 cm
\textcircled{4} A luminous flux: 0.054 mlm

The devices were equipped with filters to block unneeded light beyond the target wavelength range and were pointed towards the animals in direct contact with the outer surface of the cage. The animals were divided into a 610 nm group (n=11), a 710 nm group (n=11), and a control group (n=8). Each subject in the experimental group of 610 nm or 710 nm was irradiated by an LED device for 12 hours per day in accordance with the light cycle, while the control subjects were not exposed to LED light at all. The LED devices were provided by Qray Corporation (Seongnam, Korea) and the photometric features were measured by spectrometric instruments (CAS 140CT, Instrument systems GmbH, Munich, Germany). The treatment was continued for 28 consecutive days. A 540 nm wavelength was arbitrarily selected to study the effects of short-wavelength light in a visible light region, and RT-PCR was performed after investigating the results of irradiation of a 540 nm group (n=5) using the same method for the same period. After 4 weeks of irradiation, the rats were bred for 5 more weeks without exposure to LED light to check phaseout of the LED-induced immunological effect.

### Flow Cytometry

Peripheral blood mononuclear cells (PBMC) were obtained by separating heparinized blood from 1.5 ml of blood collected from a rat on a Ficoll-paque (Amersham Bioscience, Uppsala, Sweden) density gradient centrifuge. For 1 hour, 5×10⁵ cells per tube were incubated with 0.25 μg of PE-conjugated anti-rat-CD4 antibody (BD Bioscience Pharmigen, Cambridge, U.K.) or PE-conjugated anti-rat-CD8a antibody (BD Bioscience Pharmigen, Cambridge, U.K.) on ice and washed twice in PBS with 5% fetal bovine serum. The fluorescence was measured by a flow cytometer (FACS Calibur, Beckton-Dickinson, Mountain View, Calif., USA) and Cell Quest Pro software (Beckton-Dickinson, Mountain View, Calif., USA).

### RT-PCR

Total RNA was extracted from 1 ml of whole blood collected from a tail vein with QiaAmp RNA blood mini (Qiagen, Hilden, Germany) according to the manufacturer's instructions. By Superscript II (Invitrogen, Branfort, Conn., USA), 2 μg of total RNA was subjected to reverse transcription and then 2 μl of the resulting cDNA was amplified by the polymerase chain reaction (PCR) technique. The sequence of PCR primers for IL-1β, IL-4, IL-6, and IFNγ were listed in Table 1. After samples had been denatured at 94° C. for 2 minutes, the PCR amplification was performed for 30 cycles. Each PCR cycle consisted of a melting at 94° C. for 20 seconds, an annealing at 58° C. for 40 seconds, and an elongation at 72° C. for 1 minute. The PCR products were visualized on 1% agarose gel.

| | | | Product |
|---|---|---|---|
| Target | Dir- | | size |
| gene | ection | Sequence | (bp) |
| IL-1β | Sense | 5′-CTGTCCTGATGAGAGCATCC-3′ | 330 |
| | Reverse | 5′-TGTCCATTGAGGTGGAGAGC-3′ | |
| IFNγ | Sense | 5′-GCTGTTACTGCCAAGGCACA-3′ | 400 |
| | Reverse | 5′-CGACTCCTTTTCCGCTTCCT-3′ | |
| IL-4 | Sense | 5′-GAGCTATTGATGGGTCTCAGC-3′ | 400 |
| | Reverse | 5′-GGCTTTCCAGGAAGTCTTTCA-3′ | |
| IL-6 | Sense | 5′-ACAAGTCCGGAGAGGAGACT-3′ | 490 |
| | Reverse | 5′-GGATGGTCTTGGTCCTTAGC-3′ | |

### Flow Cytometry Analysis of CD4+ and CD8+ T-Cell Population in PBMC

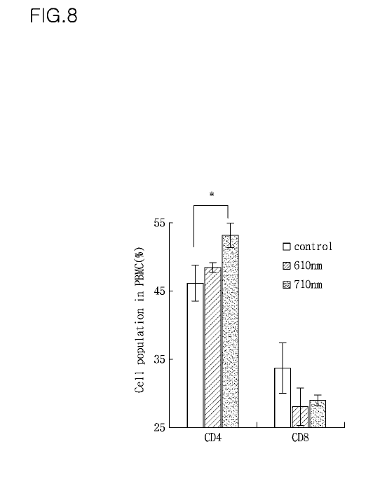

FIG. 7 is a diagram showing results obtained by measuring CD4+ and CD8+ T-cell population using a flow cytometer before LED light irradiation, and FIG. 8 is a diagram showing results obtained by measuring CD4+ and CD8+ T-cell population using a flow cytometer after LED light irradiation for 28 days. Interestingly, as shown in FIGS. 7 and 8, CD4+ T-cell subset population of 710 nm LED-irradiated rats increased significantly (p<0.05), but the same result was not found in the 610 nm group and control group. The percentile population of CD8+ T-cells decreased apparently in LED-irradiated groups, but the decrease was statistically insignificant.

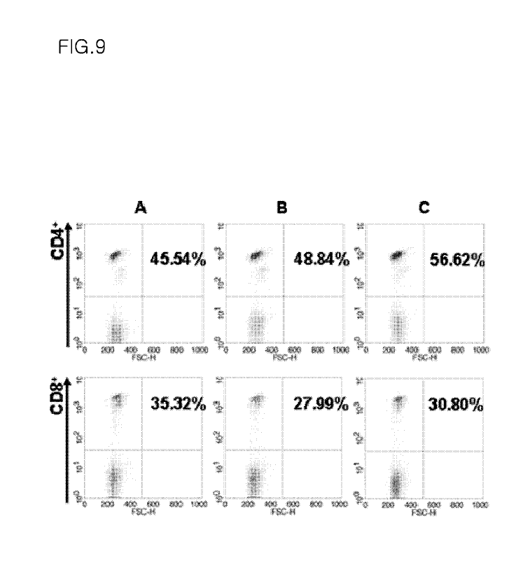

FIG. 9 is a flow cytometry data diagram showing the distributions of CD4+ and CD8+ T-cell subset population of experimental groups after LED irradiation of the experimental groups for 4 weeks.

PBMC was extracted from the whole blood sample, the PBMC was stained by PE-conjugated anti-rat-CD4 antibody or by PE-conjugated anti-rat-CD8a antibody, and then flow cytometry was applied to the control rat group (A), the 610 nm LED-irradiated rat group (B), and the 710 nm LED-irradiated rat group (C).

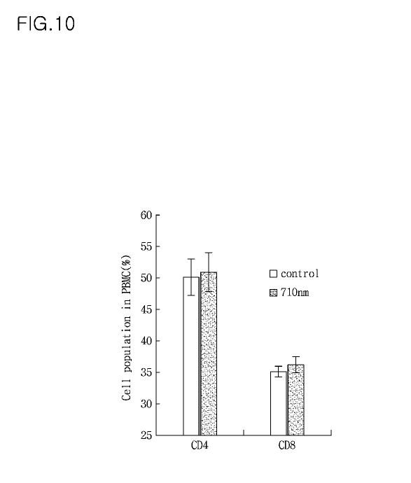

FIG. 10 is a diagram showing results obtained by measuring CD4+ and CD8+ T-cell population of experimental groups using a flow cytometer after the experimental groups were deprived of LED light for 5 weeks. After 4 weeks of LED phototherapy, the rats in the 710 nm group were deprived of LED light for 5 weeks in order to check if the increased CD4+ T-cell subset population could be reversed. Without the 710 nm LED irradiation, the CD4+ T-cell subset population returned to the control level.

### RT-PCR for Cytokines Expressions

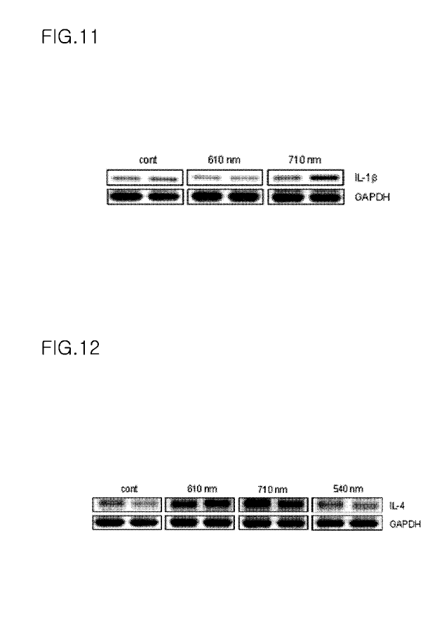

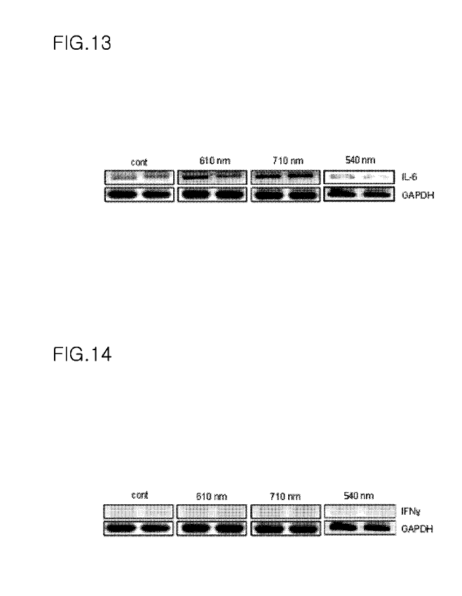

After 4 weeks of LED irradiation, total RNA was isolated from the whole blood sample and RT-PCR was performed to examine the expression of cytokine transcripts. As shown in FIGS. 11 through 14, there were minor changes in cytokine transcripts of IL-1β and IL-6. The transcript level of IL-1β slightly increased in the 710 nm group (FIG. 11) and the transcript level of IL-6 increased weakly in both the 610 nm and 710 nm LED groups compared to the control group (FIG. 13). IFNγ transcripts were not detected in any group (FIG. 14). On the other hand, IL-4 mRNA was markedly induced in both the 610 nm and 710 nm groups (FIG. 12).

### Conclusion

This work shows for the first time through flow cytometry that the preferential proliferation of CD4+ helper T-cells is induced by irradiation by 710 nm-wavelength light in the in vivo rat model. Also, the flow cytometry result is supported by the finding that 710 nm LED light increases the expression of IL4-mRNA generated mainly by CD4+ helper T-cells when cytokine production was analyzed in nucleic acids using PT-PCR. Meanwhile, 710 nm LED light increases CD4+ T lymphocytes but does not affect the production of cytokine such as IL-1β and IL-6 which are potent inducers of acute phase proteins used as an index of inflammatory reaction.

Through cytokine analysis in nucleic acids using RT-PCR, it was found that the other prominent wavelength of the light source, 610 nm LED light, also increases the expression of IL-4 mRNA and thus affects the activation of CD4+ helper T-cells. However, it can be inferred through the results of cytokine analysis that a short wavelength of 540 nm in the visible light region has no significant influence on the activation of CD4+ helper T-cells.

The effects of LED visible light having a 710 nm or 610 nm wavelength on the proliferation and activation of CD4+ T lymphocytes which play a central role in cell-mediated immunity indicate that 710 nm and 610 nm visible light can be useful tools in immunotherapy.

While exemplary embodiments of the present invention have been described above, it will be apparent to those skilled in the art that various modifications can be made to the described embodiments without departing from the spirit or scope of the invention as defined by the appended claims and their equivalents.

What is claimed is:

1. A backlight unit with a health-care function, comprising:
a light source including a plurality of light-emitting diodes (LEDs), at least some of the plurality of LEDs radiating light having a wavelength beneficial to the human body; and
an optical output unit outputting the light radiated from the light source to a liquid crystal panel.

2. The backlight unit of claim 1, wherein the at least some of the LEDs radiate light of a specific incoherent wavelength of 610±20 nm or 710±30 nm.

3. The backlight unit of claim 1, wherein the at least some of the LEDs radiate light of a specific incoherent wavelength of 610±5 nm or 710±5 nm.

4. The backlight unit of claim 2, wherein the at least some of the LEDs are a plurality of health-care lighting packages which appear as a single lighting, and a plurality of LEDs included in the health-care lighting packages are connected in parallel.

5. The backlight unit of claim 4, wherein the light source comprises a plurality of general lighting packages including a plurality of LEDs functioning as a general backlight, and a plurality of health-care lighting packages, the plurality of general lighting packages and the plurality of health-care lighting packages being arranged in alternating fashion.

6. The backlight unit of claim 5, wherein the plurality of general lighting packages further comprise at least one LED radiating light of a specific incoherent wavelength in the range of 610±20 nm or 710±30 nm.

7. The backlight unit of claim 5, wherein the plurality of general lighting packages further comprise at least one LED radiating light of a specific incoherent wavelength in the range of 610±5 nm or 710±5 nm.

8. The backlight unit of claim 5, wherein each of the general lighting packages and the health-care lighting packages is inserted into a hole formed in a light guide panel of the optical output unit.

9. The backlight unit of claim 2, further comprising a filter sharply limiting wavelength band characteristics of visible light radiated from the at least some of the LEDs.

10. The backlight unit of claim 3, wherein the at least some of the LEDs are a plurality of health-care lighting packages which appear as a single lighting, and a plurality of LEDs included in the health-care lighting packages are connected in parallel.

11. The backlight unit of claim 10, wherein the light source comprises a plurality of general lighting packages including a plurality of LEDs functioning as a general backlight, and a plurality of health-care lighting packages, the plurality of general lighting packages and the plurality of health-care lighting packages being arranged in alternating fashion.

12. The backlight unit of claim 11, wherein the plurality of general lighting packages further comprise at least one LED radiating light of a specific incoherent wavelength in the range of 610±20 nm or 710±30 nm.

13. The backlight unit of claim 11, wherein the plurality of general lighting packages further comprise at least one LED radiating light of a specific incoherent wavelength in the range of 610±5 nm or 710±5 nm.

14. The backlight unit of claim 11, wherein each of the general lighting packages and the health-care lighting packages is inserted into a hole formed in a light guide panel of the optical output unit.

15. The backlight unit of claim 3, further comprising a filter sharply limiting wavelength band characteristics of visible light radiated from the at least some of the LEDs.

16. The backlight unit of claim 1, wherein the light source is a plurality of lighting packages which appear as a single lighting, each lighting package including a plurality of LEDs functioning as a general backlight, and at least one LED for health-care radiating light of a specific incoherent wavelength in the range of 610±20 nm or 710±30 nm.

17. The backlight unit of claim 1, wherein the light source is a plurality of lighting packages which appear as a single lighting, each lighting package including a plurality of LEDs functioning as a general backlight, and at least one LED for health-care radiating light of a specific incoherent wavelength in the range of 610±5 nm or 710±5 nm.
